(19) United States
(12) Patent Application Publication
(10) Pub. No.: US 2015/0345044 A1
(43) Pub. Date: Dec. 3, 2015

(54) METHOD OF ELECTROPLATING COBALT ALLOY TO WIRING SURFACE

(71) Applicant: NATIONAL CHUNG SHAN INSTITUTE OF SCIENCE AND TECHNOLOGY, Longtan Township (TW)

(72) Inventors: Chi-Haw CHIANG, Longtan (TW); Chih WANG, Longtan (TW); Yu-Ping WANG, Longtan (TW); Chun-Yu LEE, Longtan (TW); Ren-Ruey FANG, Longtan (TW); Yang-Kuo KUO, Longtan Township (TW)

(73) Assignee: NATIONAL CHUNG SHAN INSTITUTE OF SCIENCE AND TECHNOLOGY, Longtan Township (TW)

(21) Appl. No.: 14/289,828

(22) Filed: May 29, 2014

(51) Int. Cl. C25D 5/16; C25D 5/10; B23K 1/00; B23K 31/02; B23K 1/20; C25D 7/06; C25D 5/18

(52) U.S. Cl. CPC C25D 5/16; C25D 7/0607; C25D 5/10; C25D 5/18; B23K 31/02; B23K 1/20; B23K 1/0016

(57) ABSTRACT

A method of electroplating a cobalt alloy to a wiring surface includes providing a substrate having a metal wiring; electroplating a cobalt-based alloy to the metal wiring at a deposition rate of 15-30 μm/hr to form thereon a cobalt-based alloy electroplated layer 0.5 μm-5 μm thick, wherein the main constituent element of the cobalt-based alloy is cobalt; plating gold to the cobalt-based alloy electroplated layer to form thereon a gold plated layer 0.03 μm-0.3 μm thick. The surface of the cobalt-based alloy electroplated layer features a crystalline-phase structure full of micro-protuberances, and the thickness of the gold plated layer is reduced to 0.03 μm.

### FIELD OF TECHNOLOGY

The present invention relates to wiring surface treatment methods, and more particularly, to a method of electroplating a cobalt-based alloy and gold to a metal wiring to form a barrier layer thereon, so as to reduce the gold plated layer thickness.

### BACKGROUND

According to the prior art, regarding an interposer substrate or an integrated circuit substrate (IC substrate) for use in semiconductor packaging, its wiring (usually made of copper or copper alloy) connects a connection pad, a terminal, and a pin of components with a view to maintaining a contact resistance value. The connection pad and the terminal undergo surface treatment, such as electroless nickel/gold or electro nickel/gold, so as to form a barrier layer, which is applicable to package-related connection processes, such as soldering and wire bonding, to reduce solder diffusion between solder bumps when tin copper alloy is involved. Surface treatment of the connection pad, the terminal, and the pin surface during the wiring connection processes are disclosed in the prior art. US2008/0257742 A1 discloses a method of manufacturing a printed circuit board for a chip scale package (CSP), including the steps of performing surface treatment on the pads of a surface mount device (SMD) and a printed circuit board wiring, and performing electroless nickel immersion gold (ENIG) to form pads for use with an electroless nickel/gold plated layer on a copper wiring. Taiwan Patent 1419275 is directed to a substrate with a plurality of electrical contact pads and wirings and discloses a method for forming a surface treatment-related layer on electrical contact pads and subsequent processes.

Taiwan Patent 1420753 discloses a terminal for use with an electrical connector. But Taiwan Patent 1420753 has a drawback, that is, if a gold plated layer for use with a terminal contact portion and a soldering portion of the electrical connector is overly thin, there will be deterioration of the electrical conduction, corrosion inhibition, and resistance to wear and tear of a terminal of the electrical connector. If the gold plated layer is too thick, the production cost of the electrical connector terminal will increase. To avoid the aforesaid disadvantageous situations, Taiwan Patent 1420753 discloses that the soldering portion gold layer is of a thickness of 0.05 μm-0.15 μm, and the gold layer of the contact portion is of a thickness of at least 0.076 μm. To achieve reduction of contact impedance, enhancement of corrosion inhibition, and enhancement of slidability of the electrical connector, the electrical connector terminal is plated fully with nickel to prevent terminal oxidation and then the nickel-plated electrical connector terminal is plated with gold to enhance the corrosion inhibition and enhance the electrical conductivity of the electrical connector terminal

Application of electroless nickel/gold to the surface treatment of a conventional wiring connection terminal of a printed circuit board or a connector is confronted with the following problems:
1. The electroless nickel/gold process is carried out with an electrolyte at a temperature of 80° C.-90° C. and thus is likely to compromise precise components therein. Moreover, photoresists for use in defining connection terminal points and wiring patterns fail to remain intact when they come into contact with the extremely hot chemical electrolyte and thus the photoresists are susceptible to degradation, deformation, and detachment.
2. The gold layer has a thickness of 0.05 μm-0.5 μm. Considering the high prices of the raw materials for use in this process, the thickness of the gold layer formed by the technique for performing the aforesaid surface treatment is of vital importance. To address the aforesaid concern, related improvements are being made, and alternative solutions have been developed, namely electroless nickel palladium gold plating.
3. As regards the application of a conducting wire to a connection terminal, with its plugging and unplugging being carried out repeatedly, considerations must be given to related physical properties of the surface treatment layer (such as the ENIG layer), that is, resistance to wear and tear.

The descriptions above and below are intended to illustrate the techniques and means of fulfilling the objectives of the present invention and the anticipated advantages thereof The other objectives and advantages of the present invention are also described below.

### SUMMARY

To overcome the aforesaid drawbacks of the prior art, the present invention provides a method of electroplating a cobalt alloy to a wiring surface, so as to reduce the thickness of a gold plated layer formed on the cobalt alloy electroplated layer and enhance its resistance to wear and tear.

According to the present invention, as its name indicates, the cobalt-based alloy has cobalt functioning as its most numerous constituent. The advantages of the cobalt-based alloy include high hot corrosion resistance, high thermal conductivity, and low thermal expansion coefficient.

The method of the present invention is characterized in that: an anti-oxidation layer is formed by means of electroplating, using cobalt or any other appropriate metal, to enhance resistance to wear and tear and thus reduce the thickness of the gold plated layer to 0.03 μm. The method of the present invention is applicable to the surface treatment of a wiring connection terminal, such as a wiring connection pad and a pin, of a semiconductor package or a printed circuit board, so as to provide barrier layer for the copper wiring, the copper-based alloy wiring, and the connection terminal of the semiconductor package or the printed circuit board.

With an electroplating process being cherished for its role in surface quality modification, it involves treating an object as a cathode, immersing the cathode in an electrolyte which contains the ions of a metal intended to be electroplated to the cathode, providing an appropriate anode opposite to the cathode, applying direct current (DC) to both the cathode and the anode such that the metal ions in the electrolyte are deposited on the surface of the cathode. In doing so, the resultant plated layer is crystalline and delicate, and its physical properties, appearance, and dimensions are advantageously different from pre-electroplating ones so as to add economic values to the object. Depending on what metal is electroplated to the object, the electroplated layer serves a decorative purpose (when the metal is one of the conventional noble metals) and features enhanced surface hardness, enhanced resistance to wear and tear, enhanced corrosion inhibition, and enhanced electrical conductivity of the object. The other important factors in the electroplating process include the color, hardness, uniformity, coverage, thickness, and solderability of the electroplated layer.

Electroless plating, also known as chemical or auto-catalytic plating, involves either turning the surface of an object into one capable of undergoing a catalytic reaction or providing an object whose surface is inherently catalytic, and reducing the metal ions of electrolyte to the metal. The advantages of electroless plating include high uniformity of the plated layer, uniform thickness of every part of the plated layer regardless of the shape of the object, dispensing with any electroplating apparatus, wide applications (such as glass, plastics, and ceramics), and the plated layer has a smaller pore size than the electroplated layer.

Before undergoing electroplating or chemical electroplating, the material to be plated must undergo a series of pre-treatment processes, including de-greasing (removing oils from surfaces), rinsing (washing the surfaces with cold water or hot water to remove stains or residuals of a de-greasing agent used in the above de-greasing process), acid cleaning (removing scaling or oxidized layers), activation (activating the surfaces of the object by an acid to promote the adhesion of the plated layer), and beaching (removing residuals of the acid). Unsatisfactory electroplating pre-treatment compromises the binding force between the plated layer and the object, thereby causing the plated layer to detach from the object. The binding force between the plated layer and the object will be strong, if the crystallites of the plated layer are small and impurity-free. The other factors in the binding force between the plated layer and the object include the constituents of the electroplating bath and the current density. The crystallites of the plated layer will be small in the event of a low concentration of the electroplating bath and low current density.

Gold for use in industrial electroplating comes in two categories, namely hard gold and soft gold. It is impossible for gold to react with copper directly. Hence, the process of electroplating gold to a copper wiring mounted on a circuit board entails electroplating nickel to the copper wiring and then electroplating gold to the nickel electroplated layer. In this regard, the difference between hard gold and soft gold lies in the aforesaid outermost gold electroplated layer. Pure gold is softer than gold alloys; hence, pure gold is for use as soft gold, whereas gold alloys are for use as hard gold. The conventional surface treatment methods for use with electroless nickel/gold (electroless nickel immersion gold, ENIG) yield a smoother electroplated layer surface than electroplating does. Gold plated layer produced by ENIG is made of pure gold and thus categorized as soft gold. A nickel electroplated layer, which can be produced by numerous conventional circuit board surface treatment methods, is advantageously characterized by high anti-friction capability and high anti-oxidation capability, and thus the nickel electroplated layer can be for use in a connector's contact surface treatment and for use in serving a special purpose related to slidable contact components.

The present invention provides a method of electroplating a cobalt alloy to a wiring surface. The method comprises the steps of: providing a substrate having a metal wiring; electroplating a cobalt-based alloy to the metal wiring at a deposition rate of 15-30 μm/hr to form thereon a cobalt-based alloy electroplated layer 0.5 μm-5 μm thick, wherein the main constituent element of the cobalt-based alloy is cobalt; plating gold to the cobalt-based alloy electroplated layer to form thereon a gold plated layer 0.03 μm-0.3 μm thick. The surface of the cobalt-based alloy electroplated layer features a crystalline-phase structure full of micro-protuberances, and the thickness of the gold plated layer is reduced to 0.03 μm.

In an embodiment of the present invention, the gold plated layer is made of gold in the form of pure gold, gold cobalt alloy, or gold nickel alloy, wherein tin or a tin-based alloy is soldered to the gold plated layer.

The process of electroplating an alloy plated layer is usually speeded up by carrying out the process at a high current density and thus a high deposition rate. However, in the event of an overly high current density, there is a lack of metal ions in the vicinity of the cathode immersed in the electrolyte, and thus the cathode produces hydrogen gas faster and thereby increases the pH value of the electrolyte in the vicinity of the surface of the plated layer. As a result, any alkaline salts or hydroxides produced are likely to be adsorbed to the plated layer and thus deposited thereon in a powder-like or spongy form, thereby compromising the physical properties of the plated layer.

Furthermore, composite electroplating entails uniformly distributing and depositing one or more solid particles insoluble in a plating solution or a specific metallic alloy in the plating solution on a substrate to form a compact flat plated layer, wherein the secondary metal content of the plated layer equals at least 1%, such that two or more metals undergo a co-plating process also known as alloy deposition. The alloy deposition involves performing co-deposition on two or more metals by chemical electroplating, wherein co-deposition includes co-deposition of non-metals. The alloy plated layer which results from the co-deposition of two metal ions is known as a binary alloy plated layer, and the alloy plated layer which results from the co-deposition of three metal ions is known as a ternary alloy plated layer. The main (i.e., the most numerous) constituent of the cobalt-based alloy of the present invention is cobalt, but a minor constituent element of the cobalt-based alloy is nickel, molybdenum, tungsten, or a combination thereof. The commonest form of alloys is a solid solution, which generally comes in two categories, namely a substitutional solid solution and an interstitial solid solution. In the substitutional solid solution, which consists of two elements, solute atoms substitute for solvent atoms of the crystal lattice in a manner that the crystalline structure of the solvent atoms remains unchanged, but it is possible that the lattice gets distorted just because of the presence of the solute atoms. The aforesaid lattice distortion will be readily observable in the event of a large difference in the atomic radius between the solute and the solvent. The interstitial solid solution is characterized in that: the solute atoms occupy the interstices between the solvent atoms; and the solute differs from the solvent in terms of atomic size.

In the event of a high tungsten content in the cobalt tungsten alloy, the cobalt tungsten alloy will be amorphous and thus will lack a translation cycle in the arrangement of atoms, thereby being free of crystal-related defects, say, dislocation, twin, and grain boundary. Nonetheless, the amorphous cobalt tungsten alloy has its own drawback, that is, high internal stress, which will crack the amorphous cobalt tungsten alloy if the plated layer is thick, thereby reducing the industrial applicability of the amorphous cobalt tungsten alloy. On the contrary, low internal stress and thus crack reduction is manifested by a composite alloy plated layer which is produced by the co-deposition of a metal and solid particles of high hardness. Last but not least, variation of current density has a marked effect on the composition of a plated layer formed by alloy deposition.

### BRIEF DESCRIPTION

FIG. 1 is a schematic view of a connection terminal and a barrier layer thereon according to the embodiment of the present invention;

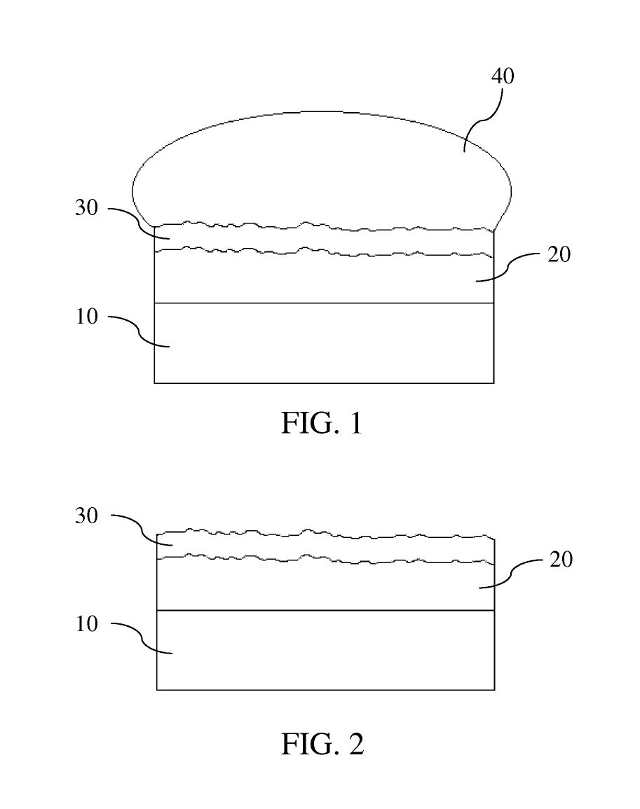

FIG. 2 is a schematic cross-sectional view of the junction of a cobalt-based alloy electroplated layer and a gold plated layer thereon according to the embodiment of the present invention; and

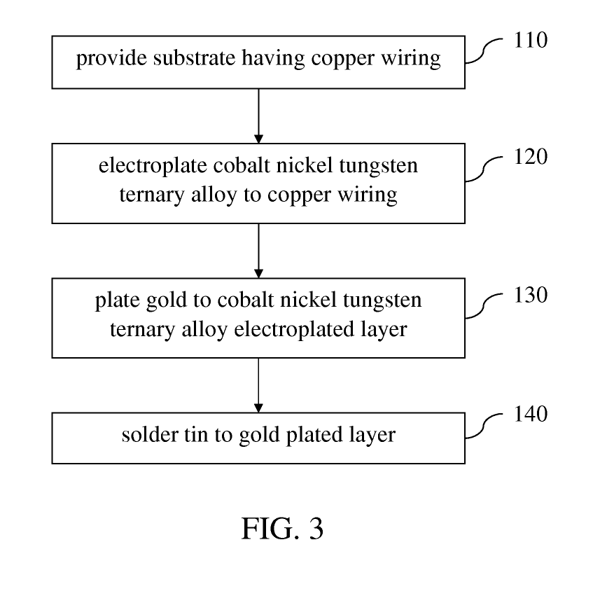

FIG. 3 is a flow chart of manufacturing the connection terminal and the barrier layer thereon according to the embodiment of the present invention.

### DETAILED DESCRIPTION

In the embodiment of the present invention, dents or cracks occur to the surface of a cobalt tungsten alloy plated layer in response to an increase in current density, because current density is proportional to deposition rate. In case of an overly high current density, consumed ions in the vicinity of the cathode will not be replaced in time and thus the deposition rate decreases. As mentioned before, the surface of the cobalt tungsten electroplated layer is coarse as a result of the overly high current density during the electroplating process. On the contrary, when the current density is not overly high, the resultant cobalt tungsten electroplated layer has a shiny surface and manifests high compactness. Tungsten atoms occupy the lattice points of the cobalt lattice to form a face-centered cubic cobalt lattice which comes in the form of a substitutional solid solution, wherein tungsten enhances the hardness of the tungsten-cobalt alloy. Tungsten increases the binding force between the atoms in the plated layer, decreases the porosity of the plated layer, increases the compactness of the plated layer, and enhances the corrosion inhibition of the plated layer.

In an embodiment of the present invention, the electroplating of a cobalt-based alloy is performed by brush electroplating or tank electroplating, wherein a cobalt tungsten alloy plated layer is produced by a power, such as a direct current (DC), a reciprocating electric power, or a pulsed electric power, and the power is of a current density of 0.1˜15 Amp/dm² (ASD).

Pulse electroplating is in wide use for performing the surface treatment of an alloy plated layer. Alloys manufactured by pulse electroplating and pulse reverse electroplating are different from alloys manufactured by direct current (DC) electroplating in terms of characteristics. Plated layers manufactured by pulse electroplating manifest satisfactory electrical conductivity, low impurity content, high hardness, and high corrosion inhibition. When pulse electroplating enhances the electrical potential and thus causes the operating electrodes to generate a large current, the large current phenomenon of the operating electrodes results in quick deposition of an alloy plated layer. On the contrary, the large current generated in the course of manufacturing the plated layer by the operating electrodes causes the operating electrodes to generate a large amount of Joule heat, thereby charring the alloy plated layer. The heat thus generated can be dissipated by a vigorous blend, so that the plated layer is charred to a minimum extent.

Referring to FIG. 1, there is shown a schematic view of a connection terminal and a barrier layer thereon according to the embodiment of the present invention. A connection terminal formed from a copper wiring 10 and adapted for use in semiconductor packaging is provided. The copper wiring 10 is electroplated with a cobalt molybdenum tungsten ternary alloy, and the cobalt molybdenum tungsten ternary alloy electroplated layer 20 is of a thickness of 0.5 μm-5 μm approximately. Then, the cobalt molybdenum tungsten ternary alloy electroplated layer 20 is plated with gold, and the gold plated layer 30 is of a thickness of 0.03 μm-0.3 μm. Eventually, a tin ball 40 is soldered to the gold plated layer 30, thereby finalizing the manufacturing of the connection terminal barrier layer. Referring to FIG. 2, there is shown a schematic cross-sectional view of the junction of a cobalt-based alloy electroplated layer and the gold plated layer 30 according to the embodiment of the present invention. The cobalt molybdenum tungsten ternary alloy is electroplated to the copper wiring 10 by direct current (DC) electroplating to form thereon the cobalt molybdenum tungsten ternary alloy electroplated layer 20. Due to the direct current (DC) electroplating, the surface of the cobalt molybdenum tungsten ternary alloy electroplated layer 20 features a crystalline-phase structure full of micro-protuberances. Then, the cobalt molybdenum tungsten ternary alloy electroplated layer 20 is plated with gold to form the gold plated layer 30. The junction of the cobalt molybdenum tungsten ternary alloy electroplated layer 20 and the gold plated layer 30, which is inherently the surface of the cobalt molybdenum tungsten ternary alloy electroplated layer 20 before the gold plated layer 30 is electroplated thereto, is coarser than one formed by electroless plating, such that the gold plated layer 30 is not only thin enough to reduce the loss of gold, but the surface of the gold plated layer 30 is coarse enough to manifest high resistance to wear and tear.

Referring to FIG. 3, there is shown a flow chart of a method of manufacturing the wiring connection terminal barrier layer according to the embodiment of the present invention. The method comprises the steps of: (step 110) providing a substrate having a copper wiring; (step 120) electroplating a cobalt nickel tungsten ternary alloy to the copper wiring at a deposition rate of 15-30 μm/hr to form thereon a cobalt nickel tungsten ternary alloy electroplated layer, wherein the cobalt content of the cobalt nickel tungsten ternary alloy is 40%; (step 130) plating gold to the cobalt nickel tungsten ternary alloy electroplated layer to form a gold plated layer thereon; and (step 140) soldering tin to the gold plated layer to thereby form a barrier layer on the connection terminal.

The embodiment of the present invention discloses electroplating a cobalt-based alloy to a copper (or copper alloy) wiring so as to form a barrier layer on a connection terminal The main constituent element of the cobalt-based alloy is cobalt. The cobalt-based alloy also contains nickel (Ni), tungsten (W), or molybdenum (Mo), so as to form a binary or ternary alloy. As compared to an electroless nickel/gold (ENIG) plated layer, the surfaces of the electroplated and plated layers of the present invention are advantageously characterized in that: first, the surface of the cobalt-based alloy electroplated layer manifests a high degree of hardness of 500˜600 HV, whereas the surface of an electroless nickel/gold plated layer has a hardness of 400˜450 HV, thereby opening to a wider range of process tolerance and materials applicable to an ensuing wire bonding process; second, the cobalt-based alloy plated layer manifests a high degree of resistance to wear and tear, reduction in the loss of the gold plated layer, and suitability for use in plugging and unplugging a connection terminal repeatedly.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method of electroplating a cobalt alloy to a wiring surface, the method comprising the steps of:
(1) providing a substrate having a metal wiring;
(2) electroplating a cobalt-based alloy to the metal wiring at a deposition rate of 15-30 μm/hr to form a cobalt-based alloy electroplated layer thereon, wherein the cobalt-based alloy electroplated layer is of a thickness of 0.5 μm-5 μm, and a most numerous constituent of the cobalt-based alloy is cobalt; and
(3) plating gold to the cobalt-based alloy electroplated layer to form a gold plated layer thereon, the gold plated layer being of a thickness of 0.03 μm-0.3 μm, so as to form a cobalt-based alloy barrier layer on the metal wiring surface by controlling the plated layer thickness and the deposition rate.

2. The method of claim 1, wherein the metal wiring is made of one of copper and copper-based alloy.

3. The method of claim 1, wherein a main constituent element of the cobalt-based alloy is cobalt, and a minor constituent element of the cobalt-based alloy is one of nickel, molybdenum, tungsten, and a combination thereof.

4. The method of claim 1, wherein the cobalt-based alloy is electroplated to the metal wiring by one of brush electroplating and tank electroplating.

5. The method of claim 1, wherein the electroplating of the cobalt-based alloy to the metal wiring is performed by a power selected from one of a direct current (DC), a reciprocating electric power, and a pulsed electric power.

6. The method of claim 5, wherein the power is of a current density of 0.1˜15 Amp/dm² (ASD).

7. The method of claim 1, further comprising (4) soldering tin or a tin-based alloy to the gold plated layer.

8. The method of claim 1, wherein the substrate of the metal wiring is a connection terminal or a pin of one of a semiconductor package, a printed circuit board, and an electrical connector.

9. The method of claim 1, wherein the gold plated layer is made of gold selected from one of pure gold, gold cobalt alloy, and gold nickel alloy.
